(19) United States
(12) Patent Application Publication
(10) Pub. No.: US 2021/0267228 A1
(43) Pub. Date: Sep. 2, 2021

(54) METHOD FOR MAKING VEGAN DAIRY PRODUCTS FROM HEMP SEED, CAULIFLOWER, AND OATS

(71) Applicant: Grounded Foods Co., Los Angeles, CA (US)

(72) Inventors: Shaun Quade, West Hollywood, CA (US); Veronica Fil, West Hollywood, CA (US)

(73) Assignee: Grounded Foods Co., Los Angeles, CA (US)

(21) Appl. No.: 17/188,260

(22) Filed: Mar. 1, 2021

Related U.S. Application Data
(60) Provisional application No. 62/982,706, filed on Feb. 27, 2020.

(51) Int. Cl. A23C 20/02; A23C 11/06; A23L 2/66; A23L 33/185; A23L 2/38; A23L 2/72; A23L 25/00

(52) U.S. Cl. CPC A23C 20/025; A23C 11/06; A23L 2/66; A23L 25/00; A23L 2/382; A23L 2/72; A23L 33/185

(57) ABSTRACT

A vegan cheese and a method to make the vegan cheese are described. The vegan cheese includes: cauliflower milk, a yeast, a salt, a butter and/or an oil, at least one starch, and at least one other ingredient. The at least one other ingredient includes: a mold, a bacterium, a fungus, a sweetener, a stabilizer, a powder, a solid food substance, a liquid, and a paste. Methods to create a hemp milk, an oat milk, and an oat and hemp milk are also described.

### CROSS-REFERENCE TO RELATED APPLICATIONS SECTION

This application is a U.S. Non-Provisional Patent Application that claims priority to U.S. Provisional Patent Application Ser. No. 62/982,706, filed on Feb. 27, 2020, the entire contents of which are hereby incorporated by reference in their entirety.

### FIELD OF THE EMBODIMENTS

The field of the invention and its embodiments relate to a vegan cheese and a method to create the vegan cheese. In particular, the present invention and its embodiments provide a method to create the vegan cheese from cauliflower.

### BACKGROUND OF THE EMBODIMENTS

Cheeses are traditionally prepared from curds formed from dairy-based milk. These curds are prepared by adding some curdling agent or coagulant to the dairy milk. Typically, a rennet is used as the final curdling agent. Further, other agents, such as an acid (e.g., lemon juice) or a combination of heat, acid, inorganic salts (e.g., calcium chloride) are used to facilitate the curdling process. Specifically, citric acid increases the acidity of the milk to facilitate the curdling process in making some types of cheeses, while calcium chloride thickens the curd. These materials are important, since the quality of cheese greatly depends upon the strength of curd.

However, the demand for cheeses having specific nutritional characteristics has increased by health-conscious consumers. Some of these consumers follow a vegan lifestyle, removing animal products from their diet. In response to this, numerous efforts have focused on the development of cheese replicas or substitutes that provide the health advantages sought by these consumers. Results of these efforts include the creation of cheeses from non-dairy ingredients.

In some instances, non-dairy milks are used to create non-dairy cheese alternatives. These non-dairy milks include nut milks, which are thickened or jelled using complex carbohydrates. However, such cheese replicas made from nut milks have unfavorable effects on texture, resulting in a final cheese-like product having a grainy consistency and lacking the creaminess of traditional dairy cheeses. Further, these cheese replicas inherit a relatively high carbohydrate content, thereby making them undesirable for some health-conscious consumers.

Further, some have attempted to develop suitable cheese substitutes from vegetable protein sources (such as soy protein). However, current processes to generate cheese substitutes from vegetable protein sources often require additional production steps and may not result in a shelf-stable cheese substitute product, unless additional steps are taken, such as pasteurization and/or refrigeration.

As such, there is a need in this technical field for an improved method for producing a vegan and non-dairy cheese option that mimics the consistency, taste, and aroma of typical dairy cheeses, while remaining vegan and having a suitable shelf-life.

### Review of Related Technology:

U.S. Published Patent Application No. 2012/0219664 A1 describes cream-cheese type compositions and methods to form these compositions. The method includes the following process steps: providing a concentrated milk composition including milk protein at a first temperature being at least about 20° F. above a melting point of the concentrated milk composition; providing a plant fat composition including plant fat at a second temperature being at least about 20° F. above a melting point of the plant fat composition; combining a first amount of the concentrated milk composition with a second amount of the plant fat composition; forming a concentrated milk-plant fat composition having an initial pH and having a concentration by weight of water being within a range of between about 49% and about 57%; combining the concentrated milk-plant fat composition together with an amount of an edible acid and directly setting the concentrated milk-plant fat composition by adjusting the initial pH to a reduced pH being within a range of between about 4.9 and about 4.5; forming a direct-set milk-plant fat product; and combining a first amount of the direct-set milk-plant fat product with a second amount of a cultured cream cheese-type product to form the cream cheese-type composition.

U.S. Published Patent Application No. 2017/0020156 A1 describes a vegetable-based cheese and a method for making the cheese. The method to make the cheese includes: preparing an emulsion of a vegetable protein concentrate and an emulsifier by utilizing a two-step homogenization process.

WO 2018/154095 A1 describes a method to prepare a vegan cheese. The method includes the following process steps: obtaining a non-dairy milk and/or emulsion; curdling the non-dairy milk/emulsion using at-least one plant-origin rennet to form a curd; and ripening to obtain the vegan cheese.

U.S. Published Patent Application No. 2018/0000105 A1 describes a non-dairy cottage cheese and a method to produce the non-dairy cottage cheese. The non-dairy cottage cheese has a curded texture and comprises about 1% to about 20% of nuts, seeds or soybeans and about 60% to about 98% water.

U.S. Published Patent Application No. 2019/0000112 A1 describes food products derived from non-animal sources that have one or more of the following: color, taste, nutritional content, and other qualities similar to those of dairy products and/or other types of food products.

Various vegan cheeses and methods to create the vegan cheeses exist. However, their composition and specific method steps to generate the cheese are substantially different from the present disclosure, as the other inventions fail to solve all the problems taught by the present disclosure.

### SUMMARY OF THE EMBODIMENTS

The present invention and its embodiments relate to a vegan cheese and a method to create the vegan cheese. In particular, the present invention and its embodiments provide a method to create the vegan cheese from cauliflower.

A first embodiment of the instant invention describes a vegan cheese. The vegan cheese is a cauliflower mozzarella cheese, a cauliflower and oat mozzarella cheese, a gruyere cheese, a cauliflower camembert cheese, or a cauliflower and hemp seed camembert cheese. It should be that other types of vegan cheeses may be produced by one or more methods of the instant invention, which are not explicitly described herein. The vegan cheese includes: a cauliflower milk in a range of approximately 200.0 grams to approximately 500.0 grams, a yeast in a range of approximately 1.0 grams to approximately 20.0 grams, a pink salt in a range of approximately 1.0 grams to approximately 6.0 grams, a butter (e.g., a coconut butter or a cacao butter) in a range of approximately 30.0 grams to approximately 110.0 grams and/or an oil (e.g., a coconut oil or a rapeseed oil) in a range of approximately 20.0 grams to approximately 95.0 grams, a starch in a range of approximately 8.0 grams to approximately 45.0 grams, a stabilizer (e.g., xanthan gum, agar agar, IOTA Carrageenan, locust bean gum, and/or kappa carrageenan) in a range of approximately 1.0 grams to approximately 27.0 grams, and at least one other ingredient.

The starch may be a tapioca starch, a potato starch, and/or a glutinous rice starch. The at least one other ingredient includes: a mold, a bacterium, a fungus, a sweetener, a powder, a solid food substance, a liquid, and/or a paste. The mold is approximately 4.0 grams to approximately 48.0 grams of shio koji (made from the fungus Aspergillus Oryzae). The bacterium is approximately 0.1 grams and includes: Lactococcus lactis subsp. Cremoris, Hafnia Alvei, Lactococcus lactis subsp. lactis biovar diacetylactis, Lactococcus lactis subsp. Lactis, Streptococcus salivarius subsp. thermophilus, Lactobacillus delbrueckii subsp. Bulgaricus, Lactobacillus helveticus, or Lactobacillus delbrueckii subsp. The fungus is approximately 0.1 grams of Geotrichum candidum or Penicillium Candidum.

The sweetener is a golden syrup, a maple syrup, and/or an agave nectar. In some examples, the sweetener is present in a range of approximately 4.0 grams to approximately 10.0 grams and is the golden syrup or the maple syrup. In other examples, the sweetener is approximately 7.5 grams to approximately 10.0 grams of the agave nectar.

The powder includes approximately 1.0 grams to approximately 6.0 grams of an onion powder, a pea protein powder, a potato protein powder, a porcini mushroom powder, and/or a yellow mustard powder. The solid food substance includes a skin of a potato and/or a skin of a garlic. The skin of the potato may be approximately 100.0 grams to approximately 175.0 grams and the skin of the garlic may be approximately 4.5 grams to approximately 11.0 grams.

The liquid includes a juice, a water, and/or a milk. The juice is approximately 10.0 grams to approximately 20.0 grams of a lemon juice. The water is present in a range of approximately 100.0 grams to approximately 220.0 grams. The milk includes approximately 45.0 grams to approximately 540.0 grams of an oat milk and/or a hemp seed milk. The paste is approximately 15.0 grams to approximately 28.0 grams of a white miso paste.

A second embodiment of the instant invention describes a method to create a vegan cheese from cauliflower. The method includes mixing cauliflower milk with a stabilizer to form a first mixture, stirring and heating the first mixture to a temperature of approximately 90° C., and blending one or more ingredients to form a paste. The one or more ingredients include at least: a yeast, a salt, a butter, an oil, a starch, and at least one other ingredient. The at least one other ingredient includes a mold, a bacterium, a fungus, a sweetener, a powder, a solid food substance, a liquid, and/or a paste.

The method then includes: adding the paste to the first mixture to form a second mixture, heating the second mixture to approximately 95° C., and placing the second mixture in a mold until the second mixture reaches a room temperature to form the vegan cheese. The method may further include removing the vegan cheese from the mold and storing the vegan cheese in a salt brine solution. The salt brine solution is a 2.5% salt brine solution that comprises approximately 500.0 grams of water mixed with approximately 12.5 grams of salt.

The cauliflower milk may be created by mixing approximately 800.0 grams of finely sliced cauliflower with approximately 75.0 grams of coconut butter and approximately 4.0 grams of a pink salt to form a mixture, stirring and heating the mixture until the mixture changes in color, and blending the mixture with approximately 1230.0 grams of water to form a puree. In some examples, the step of blending the mixture with the water to form the puree further comprises blending the mixture with approximately 600.0 grams of a brown rice rejuvelac and approximately 20.0 grams of a lemon juice.

In further examples, the step of mixing the cauliflower milk with the stabilizer to form the first mixture further comprises mixing the cauliflower milk with an oat milk and the stabilizer to form the first mixture. The oat milk may be created by soaking approximately 180.0 grams of gluten free rolled oats in approximately 1920.0 grams of filtered water for approximately 12 hours and blending the soaked oats and the water.

Another embodiment of the present invention describes a method to create a hemp milk from filtered water and hulled hemp hearts, with a ratio of the water to hemp seeds being 2:1. The method includes milling hemp seeds through a grinder to produce a hemp cream, pulling the hemp cream through one or more screens, and filtering the hemp cream through a fiber filter to create the hemp milk.

A further embodiment of the present invention describes a method to create an oat milk. The method includes: adding oats and water into a fermentation tank, maintaining a temperature of a mixture in the fermentation tank at approximately 85° F. for 48 hours, stirring the mixture in the fermentation tank every six hours to ensure even acidification during fermentation, passing the mixture over a sieve to remove pieces of the oats, and passing the mixture through a filter to remove unwanted particles to create the oat milk.

In general, the present invention succeeds in conferring the following benefits and objectives.

It is an object of the present invention to provide a vegan cheese mimicking the consistency, taste, and aroma of typical dairy cheeses.

It is an object of the present invention to provide a vegan cheese from cauliflower that mimics the consistency, taste, and aroma of typical dairy cheeses.

It is an object of the present invention to provide a method to create a vegan cheese from cauliflower that has a suitable shelf-life.

### BRIEF DESCRIPTION OF THE DRAWINGS

FIG. 1A depicts a block diagram of a method to create a cauliflower milk, in accordance with embodiments of the present invention.

FIG. 1B depicts another block diagram of a method to create a cauliflower milk, in accordance with embodiments of the present invention.

FIG. 2 depicts a block diagram of a method to create a vegan cheese from a cauliflower milk, in accordance with embodiments of the present invention.

FIG. 3 depicts a block diagram of a method to create oat kvass for use in making one or more vegan cheeses, in accordance with embodiments of the present invention.

FIG. 4 depicts a block diagram of a method to create a vegan cheese from a cauliflower milk and an oat milk, in accordance with embodiments of the present invention.

FIG. 5 depicts a block diagram of a method to create a hemp seed milk, in accordance with embodiments of the present invention.

FIG. 6 depicts a block diagram of another method to create a vegan cheese from a cauliflower milk, in accordance with embodiments of the present invention.

FIG. 7 depicts a block diagram of a method to make a vegan cheese sauce from a cauliflower milk, in accordance with embodiments of the present invention.

FIG. 8 depicts a block diagram of a method to make a vegan gruyere cheese from a cauliflower milk, in accordance with embodiments of the present invention.

FIG. 9 depicts a block diagram of a method to make a vegan camembert cheese from a cauliflower milk, in accordance with embodiments of the present invention.

FIG. 10 depicts a block diagram of a method to make a vegan feta cheese from a hemp seed milk, in accordance with embodiments of the present invention.

FIG. 11 depicts a block diagram of a method to make a vegan cream cheese from a hemp seed milk, in accordance with embodiments of the present invention.

FIG. 12 depicts a block diagram of a method to make a hemp milk, in accordance with embodiments of the present invention.

FIG. 13 depicts a block diagram of a method to make an oat milk, in accordance with embodiments of the present invention.

FIG. 14 depicts a block diagram of a method to make an oat and hemp milk, in accordance with embodiments of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

It should be appreciated that, as defined herein, “room temperature” refers to 21° C.

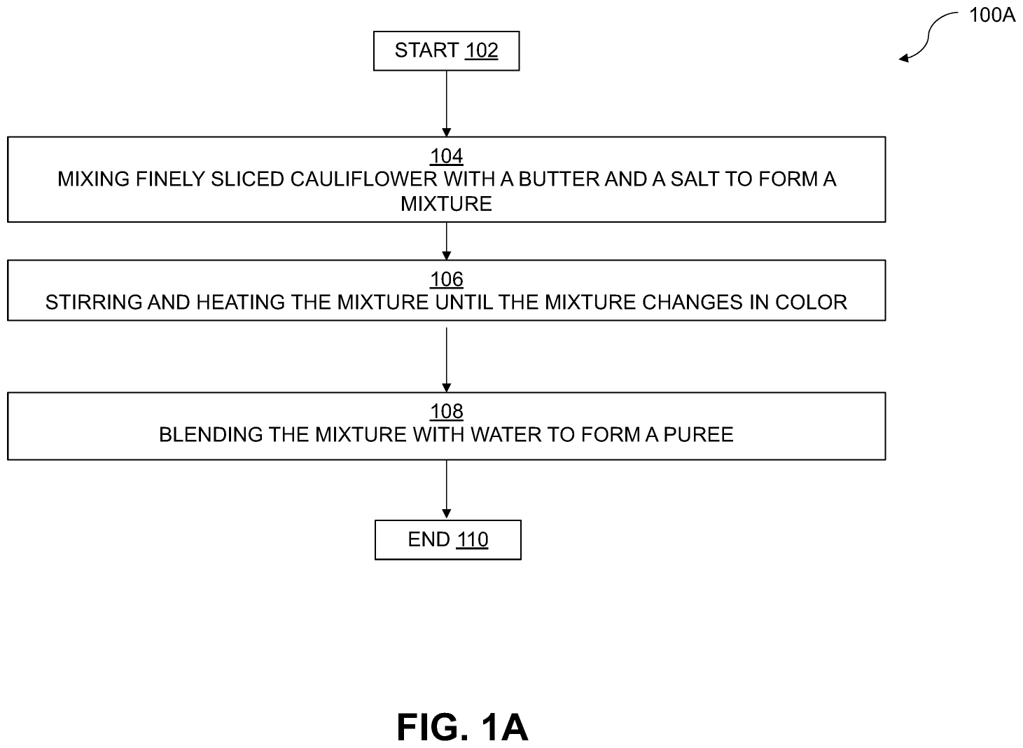

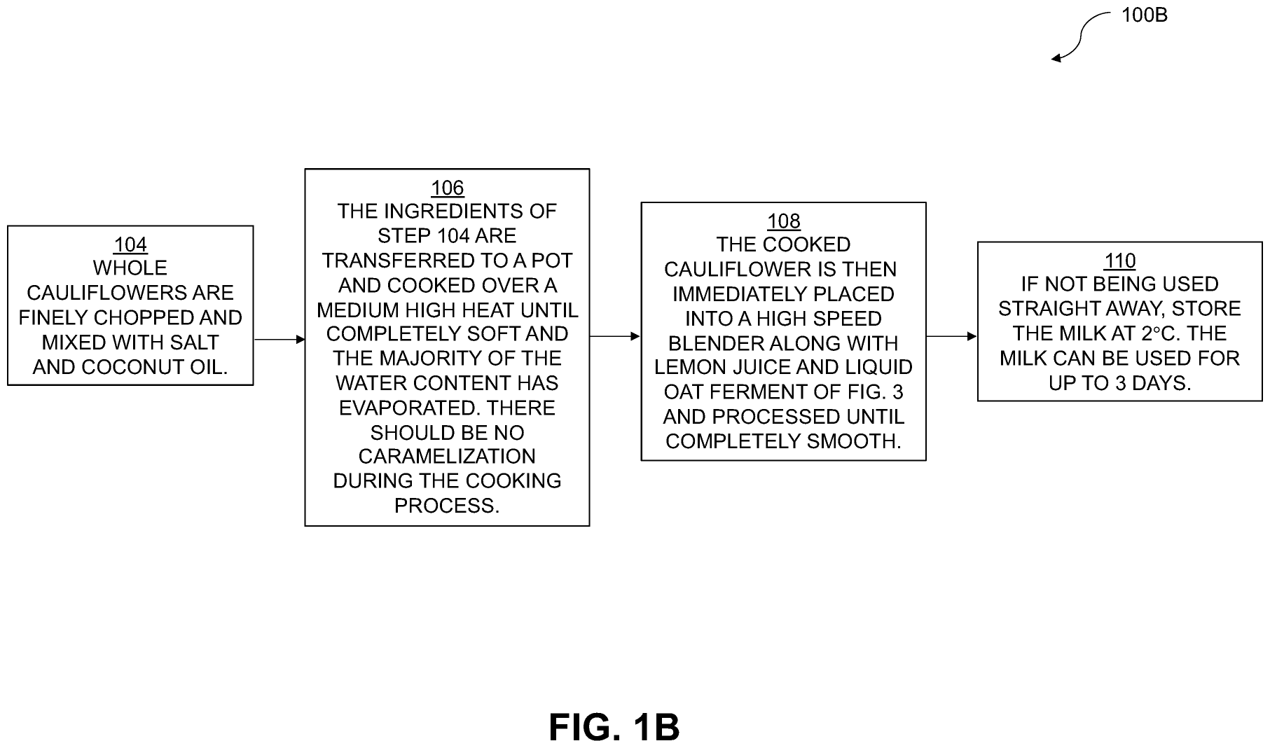

The process steps of a method 100 of FIG. 1A to create cauliflower milk begin at a process step 102. The process step 102 is followed by a process step 104 that involves mixing finely sliced cauliflower with a butter and a salt to form a mixture. The cauliflower is present in approximately 800.0 grams, the butter is approximately 75.0 grams of coconut butter, and the salt is approximately 4.0 grams of a pink salt. The process step 104 is followed by a process step 106 that includes stirring and heating the mixture until the mixture changes in color.

The process step 106 is followed by a process step 108 that includes blending the mixture with water to form a puree. The water is present in approximately 1230.0 grams. In some examples, the process step 108 may include blending the mixture with water, a rejuvelac, and a juice to form the puree. The rejuvelac is approximately 600.0 grams of a brown rice rejuvelac and the juice is approximately 20.0 grams of a lemon juice. The process step 108 is followed by a process step 110 that ends the method 100 to create the cauliflower milk. The cauliflower milk generated from the method 100 is used in the process steps of numerous figures described herein. FIG. 1B depicts another block diagram of a method 100B to create a cauliflower milk, in accordance with embodiments of the present invention.

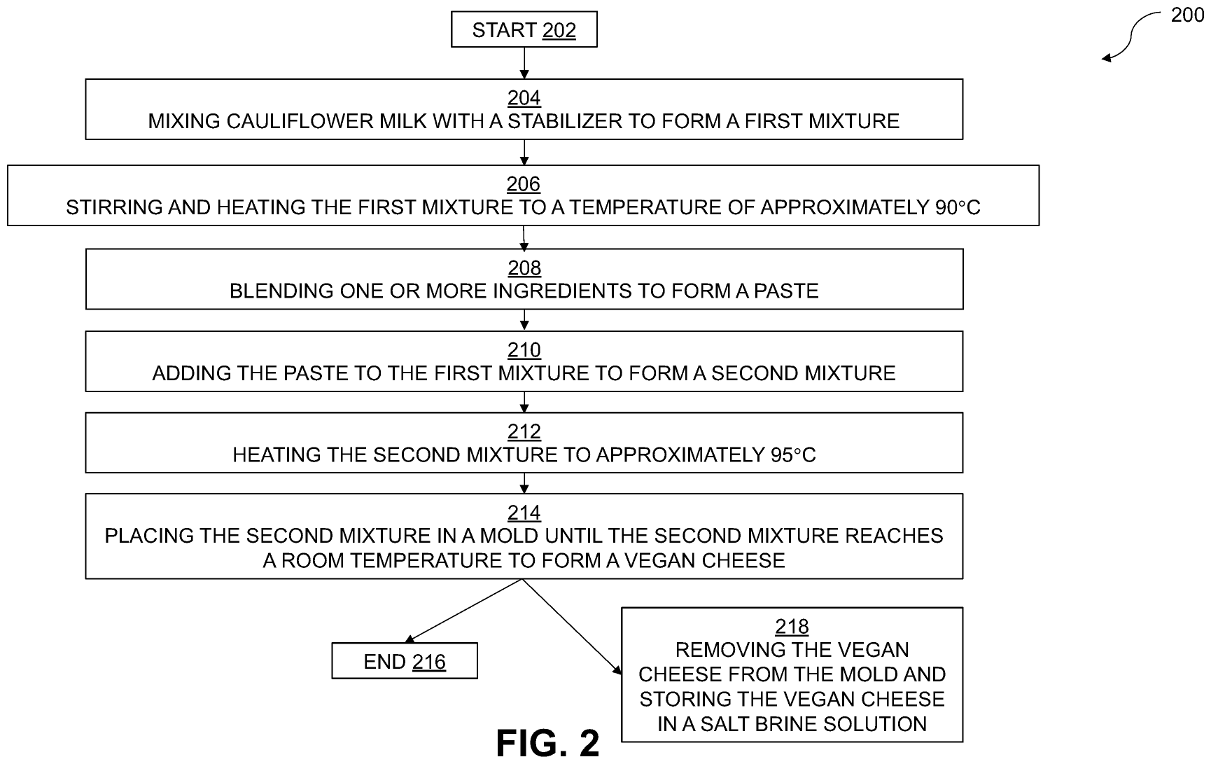

The process steps of a method 200 of FIG. 2 to create a vegan cheese from the cauliflower milk created in FIG. 1A or FIG. 1B begin at a process step 202. The process step 202 is followed by a process step 204, that includes mixing cauliflower milk with a stabilizer to form a first mixture. The cauliflower milk is present in a range of approximately 200.0 grams to approximately 500.0 grams. The stabilizer may include xanthan gum, agar agar, IOTA Carrageenan, locust bean gum, and/or kappa carrageenan, among other stabilizers not explicitly listed. The stabilizer may be present in a range of approximately 1.0 grams to approximately 27.0 grams. The process step 204 is followed by a process step 206 that includes stirring and heating the first mixture to a temperature of approximately 90° C.

The process step 206 is followed by a process step 208, that includes blending one or more ingredients to form a paste. The one or more ingredients include: a yeast, a salt, a butter and/or an oil, at least one starch, and at least one other ingredient. The at least one other ingredient includes: a mold, a bacterium, a fungus, a sweetener, a powder, a solid food substance, a liquid, and/or a paste.

The yeast is present in a range of approximately 1.0 grams to approximately 20.0 grams. The salt is a pink salt and is present in a range of approximately 1.0 grams to approximately 6.0 grams. The butter is a coconut butter or a cacao butter and is present in a range of approximately 30.0 grams to approximately 110.0 grams. The oil is a coconut oil or a rapeseed oil and is present in a range of approximately 20.0 grams to approximately 95.0 grams. The at least one starch is a tapioca starch, a potato starch, and/or a glutinous rice starch and is present in a range of approximately 8.0 grams to approximately 45.0 grams.

The mold is shio koji and is present in a range of approximately 4.0 grams to approximately 48.0 grams. Shoi koji is made from the fungus Aspergillus Oryzae. The bacterium is present in approximately 0.1 grams and is selected from the group consisting of: Lactococcus lactis subsp. Cremoris, Lactococcus lactis subsp. lactis biovar diacetylactis, Hafnia Alvei, Lactococcus lactis subsp. Lactis, Streptococcus salivarius subsp. thermophilus, Lactobacillus delbrueckii subsp. Bulgaricus, Lactobacillus helveticus, or Lactobacillus delbrueckii subsp. The fungus includes approximately 0.1 grams of Geotrichum candidum or Penicillium Candidum.

The sweetener is a golden syrup, a maple syrup, and/or an agave nectar. In examples where the sweetener is the golden syrup or the maple syrup, the sweetener is present in a range of approximately 4.0 grams to approximately 10.0 grams. In examples where the sweetener is the agave nectar, the agave nectar is present in a range of approximately 7.5 grams to approximately 10.0 grams.

The powder is present in a range of approximately 1.0 grams to approximately 6.0 grams and may include an onion powder, a pea protein powder, a potato protein powder, a porcini mushroom powder, and/or a yellow mustard powder. The solid food substance includes a skin of a potato and/or a skin of a garlic. In examples, the skin of the potato is present in a range of approximately 100.0 grams to approximately 175.0 grams. In other examples, the skin of the garlic is present in a range of approximately 4.5 grams to approximately 11.0 grams.

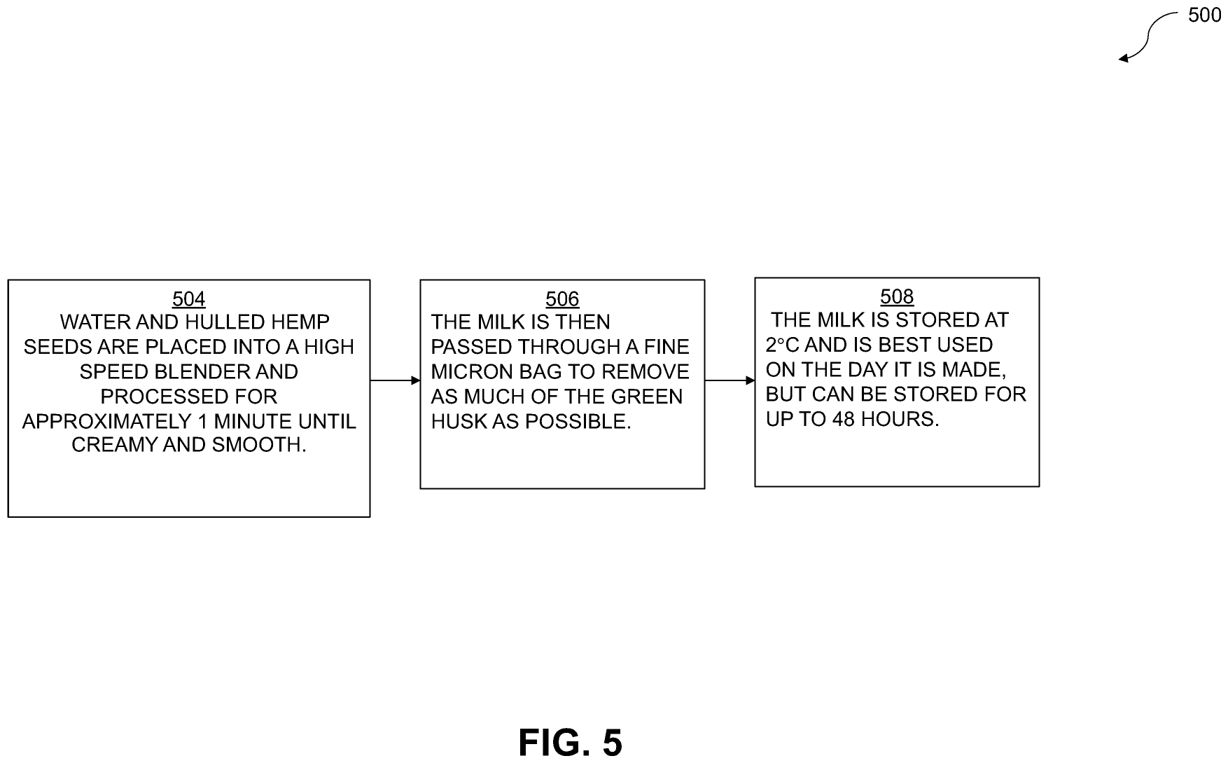

The liquid includes a juice, a water, and/or a milk. The juice is a lemon juice present in a range of approximately 10 grams to approximately 20.0 grams. The water is present in a range of approximately 100.0 grams to approximately 220.0 grams. The milk is an oat milk or a hemp seed milk (which may be created by the method 500 of FIG. 5) and is present in a range of approximately 45.0 grams to approximately 540.0 grams. The paste is approximately 15.0 grams to approximately 28.0 grams of a white miso paste.

The process step 208 is followed by a process step 210 that includes adding the paste to the first mixture to form a second mixture. The process step 210 is followed by a process step 212 that includes heating the second mixture to approximately 95° C. The process step 212 is followed by a process step 214 that includes placing the second mixture in a mold until the second mixture reaches a room temperature to form the vegan cheese. The process step 214 is followed by a process step 216 that ends the method 200 to create the vegan cheese from the cauliflower milk.

In some examples, the process step 214 may be followed by an alternative process step 218 that includes removing the vegan cheese from the mold and storing the vegan cheese in a salt brine solution. The salt brine solution is a 2.5% salt brine solution that may be formed from approximately 500 grams of water mixed with approximately 12.5 grams of salt.

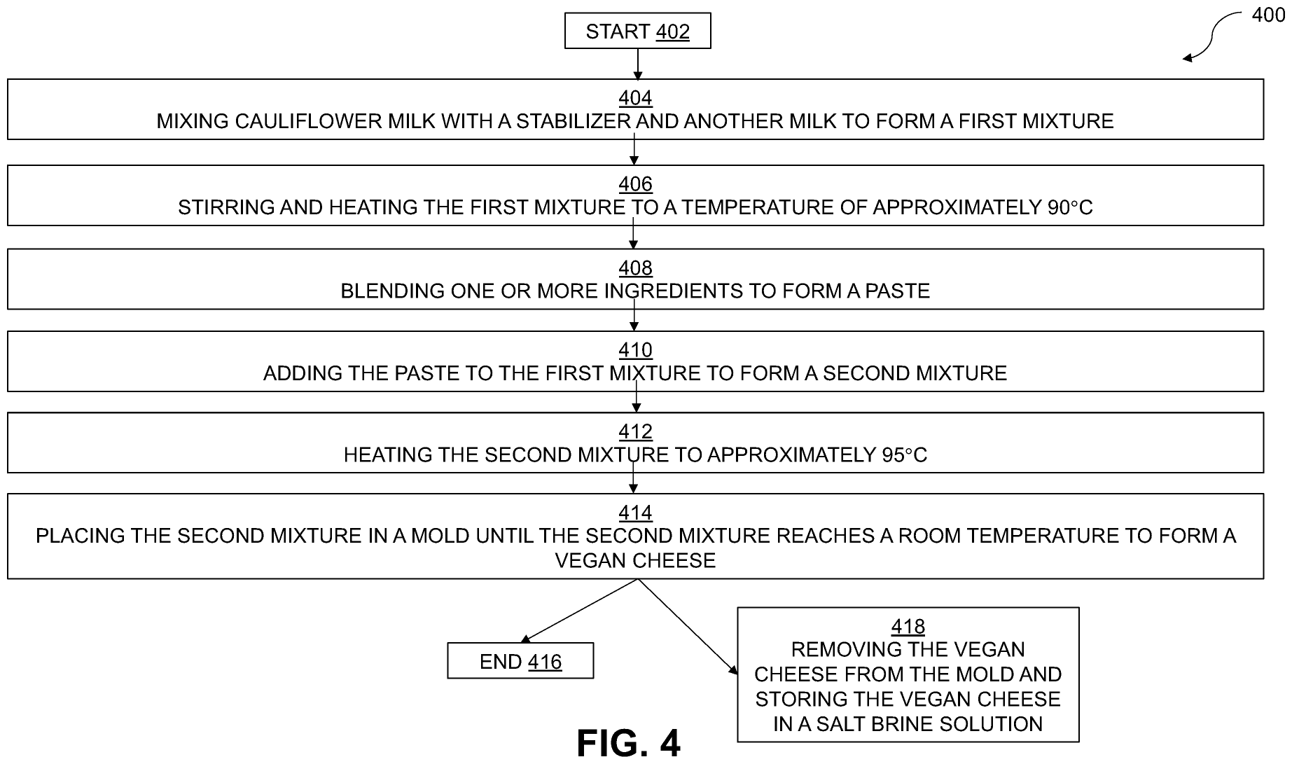

The process steps of a method 400 of FIG. 4 to create a vegan cheese from the cauliflower milk created in FIG. 1A or FIG. 1B begin at a process step 402. A process step 402 is followed by a process step 404, that includes mixing cauliflower milk with a stabilizer and another milk to form a first mixture. The other milk may include hemp seed milk (which may be formed by a method 500 of FIG. 5) or an oat milk.

The oat milk may be created by soaking approximately 180.0 grams of gluten free rolled oats in approximately 1920.0 grams of filtered water for approximately 12 hours and then blending the soaked oats and the water. The hemp seed milk may be created by the method described in FIG. 5, which includes: blending approximately 200.0 grams of hulled hemp seed with approximately 400.0 grams to approximately 700.0 grams of filtered water for approximately 2 minutes and then straining the hemp seed milk from the solution.

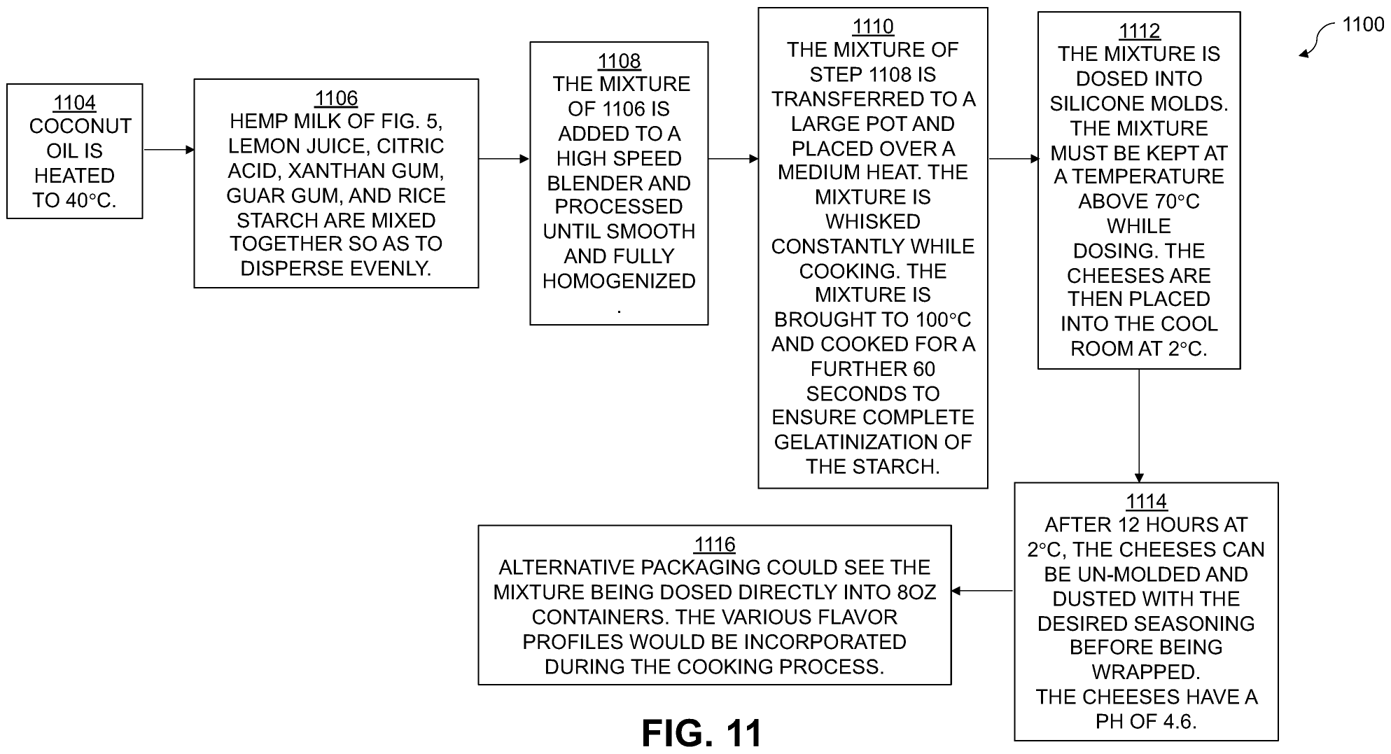

In examples, a hemp seed cream cheese may be made from the hemp seed milk by: mixing approximately 280.0 grams of hemp milk, approximately 8.0 grams of the pink salt, approximately 30.0 grams of lemon juice, approximately 1.0 grams of citric acid, approximately 1.2 grams of xanthan gum, approximately 0.6 grams of a guar gum, approximately 3.0 grams of rice starch, and approximately 100.0 grams of coconut butter heated to a temperature in a range of approximately 30° C. to approximately 35° C. until smooth. Then, the method includes placing the mixture into a stainless steel pot and cooking the mixture over a medium heat, whisking constantly until the mixture starts to bubble and has reached a temperature above 98° C. Next, the method includes placing the mixture into a container and refrigerating the mixture at approximately 2° C. for a minimum of 12 hours prior to use. The hemp seed cream cheese has a pH of approximately 4.7. It should be appreciated that another method to create a vegan cream cheese is described in a method 1100 of FIG. 11.

In some examples, a hemp seed curd may be created by the following process: blending approximately 200.0 grams of hulled hemp seed with approximately 500.0 grams of filtered water until smooth and creamy; passing the mixture through a fine micron bag and placing the bag into a small pot; stirring and heating the mixture over a low heat at approximately 90° C.; removing the mixture from the heat; allowing the milk to rest and curdle for approximately 30 minutes; and hanging the curdled milk in a cheese cloth in the refrigerator for approximately 12 hours for the excess liquid to drain off. This method creates a hemp seed curd.

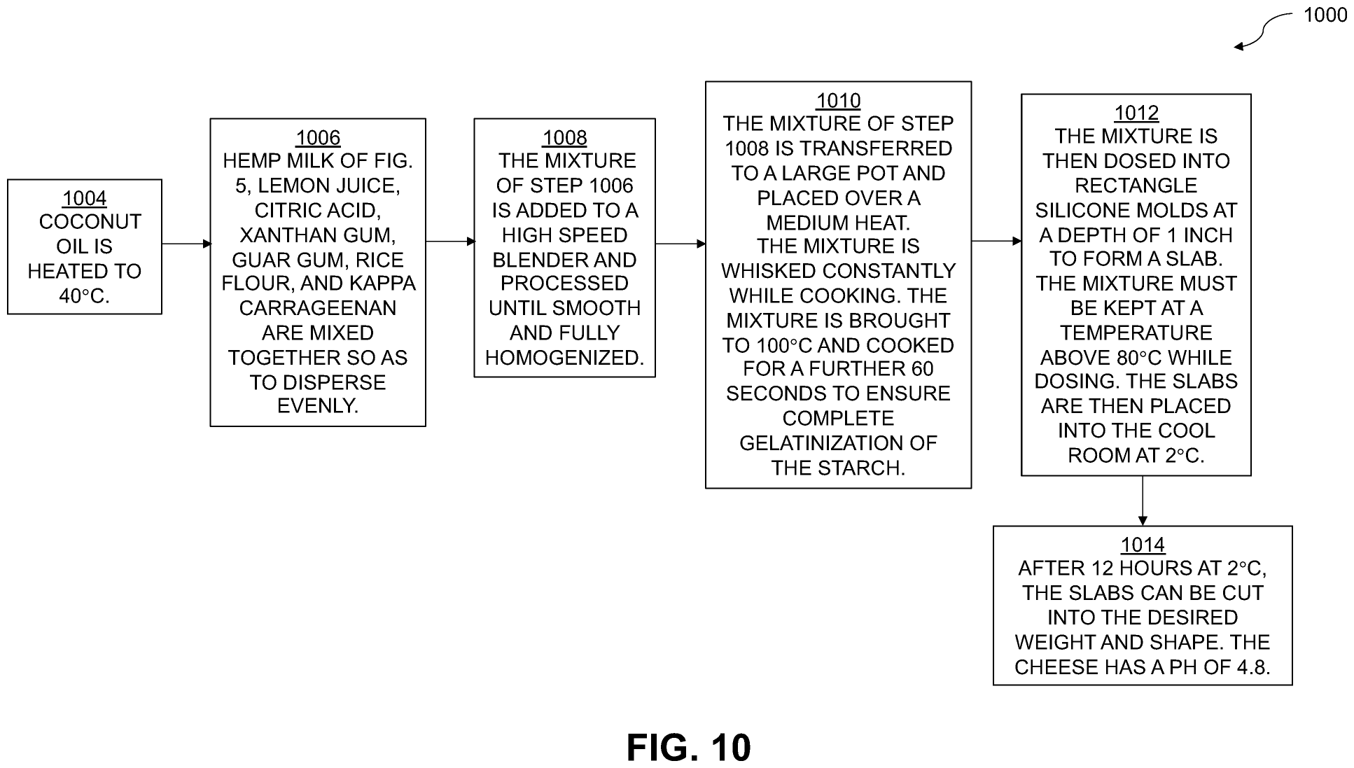

The hemp seed curd may be used to create a hemp seed feta by the following method: placing approximately 140.0 grams of the hemp seed curd, approximately 20.0 grams of lemon juice, and approximately 4.0 grams of a pink salt in the bowl of a blender and processing the contents until smooth; adding approximately 0.6 grams of xanthan gum and approximately 1.2 grams of locust bean gum to the mixture; processing the mixture until the mixture is smooth, slightly thickened and homogenized; adding approximately 50.0 grams of coconut butter (at approximately 30° C.-35° C.) until the mixture is smooth and homogenized; pouring the mixture into a mold; and refrigerating the mixture at approximately 2° C. for approximately 12 hours. The resulting hemp seed feta has a pH level of approximately 4.7. Another method to create a vegan feta cheese is described in a method 1000 of FIG. 10.

In another example, a marinade may be made that can be added to the hemp seed feta. The marinade is created by mixing the following: approximately 650.0 grams of a non-GMO canola oil, approximately 300.0 grams of extra virgin olive oil, approximately 10.0 grams of an organic garlic that is finely shaved, a zest of approximately 3 lemons, approximately 8.0 grams of thyme leaves and sprigs, and approximately 20.0 grams of Tasmanian Mountain Pepper berries.

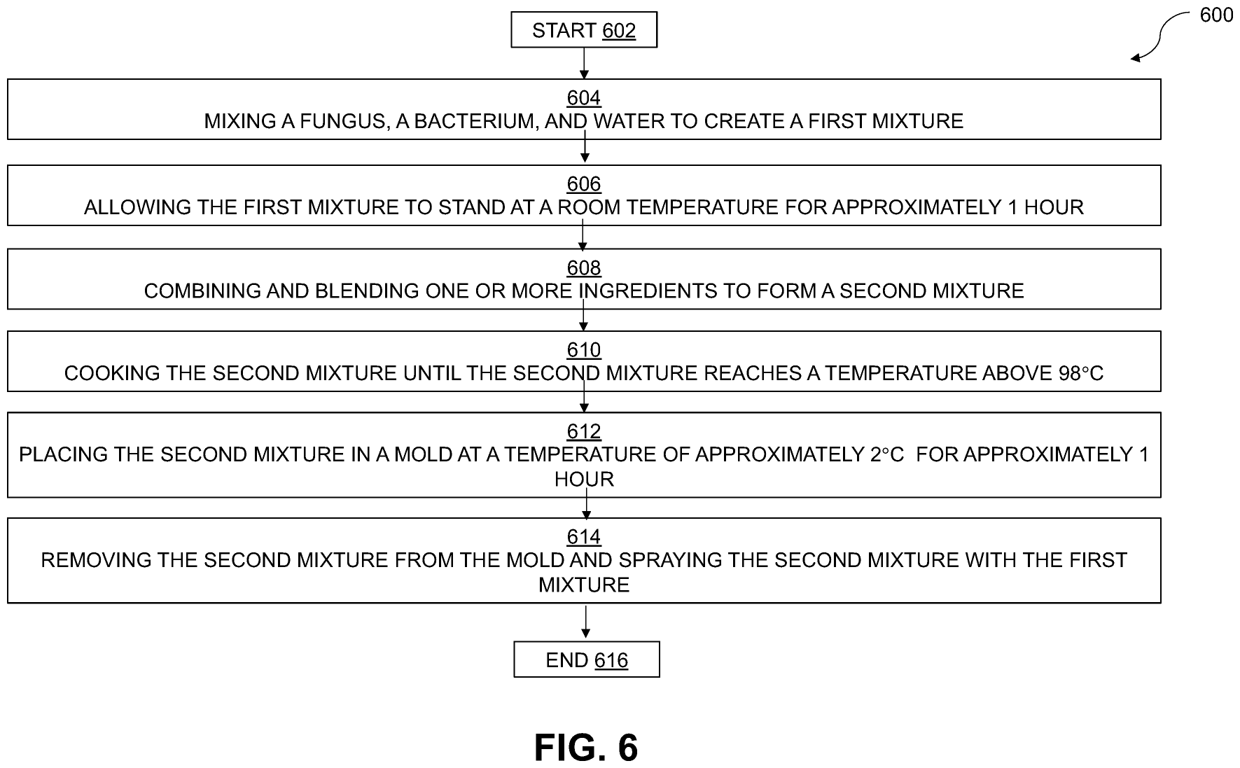

A method 600 of FIG. 6 begins with a process step 602, which is followed by a process step 604 that includes mixing a fungus, a bacterium, and water to create a first mixture. The fungus and bacterium include the examples described infra. The process step 604 is followed by a process step 606 that includes allowing the first mixture to stand at a room temperature for approximately 1 hour. The process step 606 is followed by a process step 608 that includes combining and blending the one or more ingredients to form the second mixture. The one or more ingredients include those ingredients described infra.

The process step 608 is followed by a process step 610 that includes cooking the second mixture until the second mixture reaches a temperature above 98° C. The process step 610 is followed by a process step 612 that includes placing the second mixture in the mold (e.g., the silicone mold) at a temperature of approximately 2° C. for approximately 1 hour. The process step 612 is followed by a process step 614 that includes removing the second mixture from the mold and spraying the second mixture with the first mixture. The process step 614 is followed by a process step 616 that concludes the method 600.

The vegan cheese created in the methods described infra may be a cauliflower mozzarella cheese, a cauliflower and oat mozzarella cheese, a gruyere cheese, a cauliflower camembert cheese, or a cauliflower and hemp seed camembert cheese, among other cheeses not explicitly listed herein.

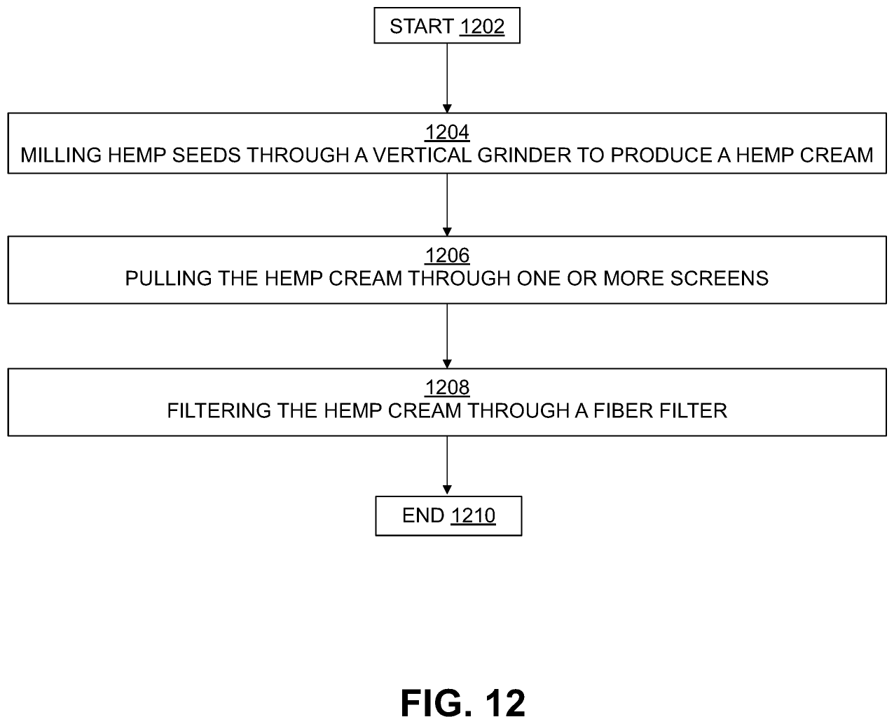

A method to create a hemp milk is also described and depicted in FIG. 12 herein. The hemp milk created by the method of FIG. 12 is created from filtered water and hulled hemp hearts, with a ratio of the water to hemp seeds being 2:1. The method of FIG. 12 begins at a process step 1202, which is followed by a process step 1204 that includes milling hemp seeds through a vertical grinder to produce a hemp cream. Next, a process step 1206 follows the process step 1204 and includes pulling the hemp cream through a series of screens, each time reducing the micron size

Then, a process step 1208 follows the process step 1206 and includes filtering the hemp cream through a fiber filter set at a 30 degree angle with a final micron size of 80. This micron size ensures that green flakes of insoluble fiber that are present at the time of milling are filtered out.

A process step 1210 follows the process step 1208 to conclude the method to create hemp milk of FIG. 12. The resulting hemp milk is a thick, raw hemp milk that is off-white in color and full of protein and calcium. No heat has been applied during this process, and as such, the structural bond of the protein strands are left intact. When combined with other ingredients in the various formulas, heat is applied gradually and these protein strands denature. This is what gives the products great structural integrity, mouthfeel and a strong nutritional profile in comparison to dairy products.

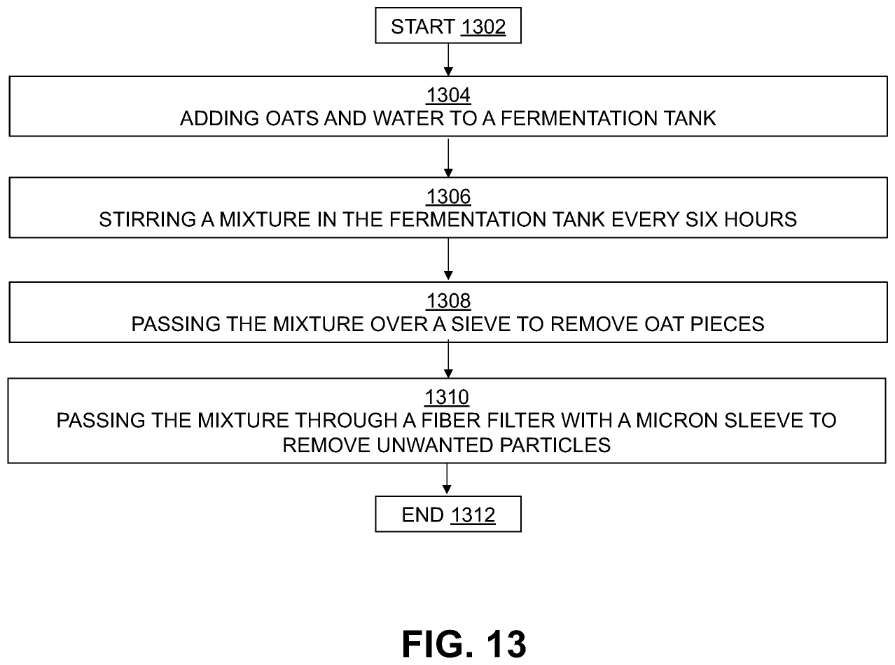

A method to create an oat milk is described and depicted in FIG. 13. The method of FIG. 13 begins at a process step 1302, which is followed by a process step 1304 that includes: adding oats and water into a large stainless steel fermentation tank. Specifically, 85.5% reverse osmosis water at 85° F. and 12.5% gluten free steel cut oats were added into the stainless steel fermentation tank. A lid of the stainless steel fermentation tank is closed, but there is still sufficient airflow in the cap of the stainless steel fermentation tank. The mixture within the stainless steel fermentation tank is kept at 85° F. for 48 hours.

A process step 1306 follows the process step 1304 and includes stirring the mixture in the stainless steel fermentation tank every six hours to ensure even acidification during fermentation. A pH after fermentation is complete is 4.7. A process step 1308 follows the process step 1306 and includes passing the mixture over a 35 degree angle hydra-sieve to remove larger oat pieces. A process step 1310 follows the process step 1308 and includes passing the mixture through a fiber filter with a micron sleeve of 86 to remove any remaining unwanted particles. A process step 1312 follows the process step 1310 to end the method of FIG. 13.

The oat milk created from the method of FIG. 13 may be chilled to 40° F. for storage of up to 7 days before use. The lactic acid bacteria fermented oat milk created from the method of FIG. 13 may be used as the basis for cheese free cheese sauces, hard cheeses (such as cheddar) and blocks for shredding and slicing, as described herein.

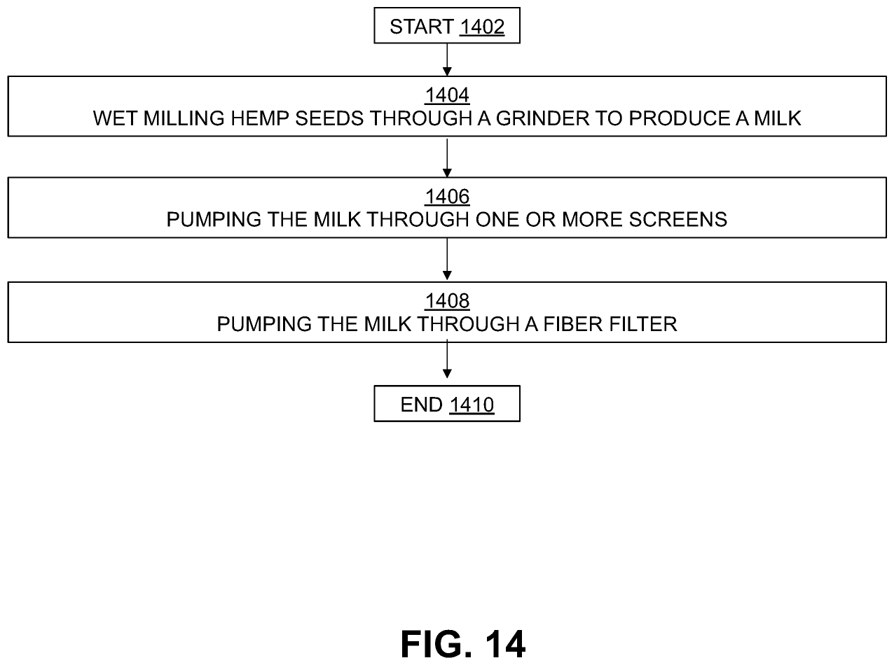

A method to create an oat and hemp milk is described and depicted in FIG. 14. The method of FIG. 14 begins at a process step 1402. The cultured oat and hemp milk is made from cultured oat milk (created by the method of FIG. 13) and hulled hemp hearts, where a ratio of the oat milk to hemp seed is 4:1. The process step 1402 is followed by a process step 1404 that includes: wet milling hemp seeds through a vertical grinder to produce a milk. The milk at this process step is a thick speckled milk.

A process step 1406 follows the process step 1404 and includes pumping the milk through one or more screens, each time reducing the micron size. A process step 1408 follows the process step 1406 and includes pumping the milk through a fiber filter set at a 30 degree angle with a final micron size of 80. This micron size ensures that green flakes of insoluble fiber that were present at the time of milling are filtered out. A process step 1410 follows the process step 1408 and concludes the method of FIG. 14.

The oat and hemp milk created by the method of FIG. 14 may be used to make a variety of dairy products in various formats. The result of the method of FIG. 14 is a thick, raw, naturally cultured hemp milk that is off-white in color, is full of protein and calcium, and has an incredible depth of flavor and umami. As no heat has been applied during these process steps, the structural bond of the protein strands are left intact. When combined with other ingredients in the various formulas, heat is applied gradually and these protein strands denature. This is what gives the products great structural integrity, mouthfeel, and a strong nutritional profile in comparison to dairy products.

### EXAMPLES

### Example 1

The method 200 of FIG. 2 is used in Example 1. The process step 204 includes mixing approximately 250.0 grams of cauliflower milk with approximately 7.5 grams of agar agar or IOTA carrageenan as the stabilizer to form a first mixture. The process step 204 is followed by the process step 206 that includes stirring and heating the first mixture to a temperature of approximately 90° C. The process step 206 is followed by the process step 208, that includes blending the one or more ingredients to form the paste. The one or more ingredients include approximately 110.0 grams of the coconut butter, approximately 175.0 grams of flesh of the potato, approximately 8.0 grams of the yeast (e.g., yeast flakes), approximately 20.0 grams of the lemon juice, approximately 6.0 grams of the pink salt, approximately 25.0 grams of the tapioca starch and/or the potato starch, and approximately 7.0 grams of the golden syrup.

The process step 208 is followed by the process step 210 that includes adding the paste to the first mixture to form the second mixture. The process step 210 is followed by the process step 212 that includes heating the second mixture to approximately 95° C. The process step 212 is followed by the process step 214 that includes placing the second mixture in the mold (e.g., a silicone mold) until the second mixture reaches a room temperature to form the vegan cheese. The process step 214 is followed by the process step 216 that ends the method 200 to create a vegan cauliflower mozzarella cheese from the cauliflower milk.

### Example 2

The method 200 of FIG. 2 is used in Example 2. The process step 204 includes mixing approximately 300.0 grams of cauliflower milk with approximately 2.2 grams of xanthan gum and approximately 2.7 grams of agar agar as the stabilizers to form a first mixture. The process step 204 is followed by the process step 206 that includes stirring and heating the first mixture to a temperature of approximately 90° C. The process step 206 is followed by the process step 208, that includes blending the one or more ingredients to form the paste. The one or more ingredients include approximately 45.0 grams of the tapioca starch, approximately 1.3 grams of the yeast (e.g., yeast flakes), approximately 1.0 grams of the onion powder, approximately 2.0 grams of the pink salt, approximately 90.0 grams of the coconut oil, approximately 220.0 grams of the filtered water, approximately 12.0 grams of the lemon juice, and approximately 2.5 grams of the pea protein powder.

The process step 208 is followed by the process step 210 that includes adding the paste to the first mixture to form the second mixture. The process step 210 is followed by the process step 212 that includes heating the second mixture to approximately 95° C. The process step 212 is followed by the process step 214 that includes placing the second mixture in the mold until the second mixture reaches the room temperature to form the vegan cheese. The process step 214 is followed by a process step 216 that ends the method 200 to create the vegan mozzarella cheese from the cauliflower milk.

### Example 3

The method 200 of FIG. 2 is used in Example 3. The process step 204 includes mixing approximately 380 grams of cauliflower milk with approximately 9 grams of agar agar or kappa carrageenan as the stabilizer to form the first mixture. The process step 204 is followed by the process step 206 that includes stirring and heating the first mixture to the temperature of approximately 90° C. The process step 206 is followed by the process step 208, that includes blending the one or more ingredients to form the paste. The one or more ingredients include approximately 40.0 grams of the tapioca starch, approximately 4.0 grams of the pink salt, approximately 11.0 grams of the flesh of garlic, approximately 3.5 grams of the onion powder, approximately 28.0 grams of the white miso paste, approximately 3.0 grams of the yeast (e.g., the yeast flakes), approximately 100.0 grams of the flesh of potato, approximately 65.0 grams of the coconut butter, approximately 25.0 grams of the potato starch, approximately 4.0 grams of the maple syrup, and approximately 12.0 grams of the lemon juice.

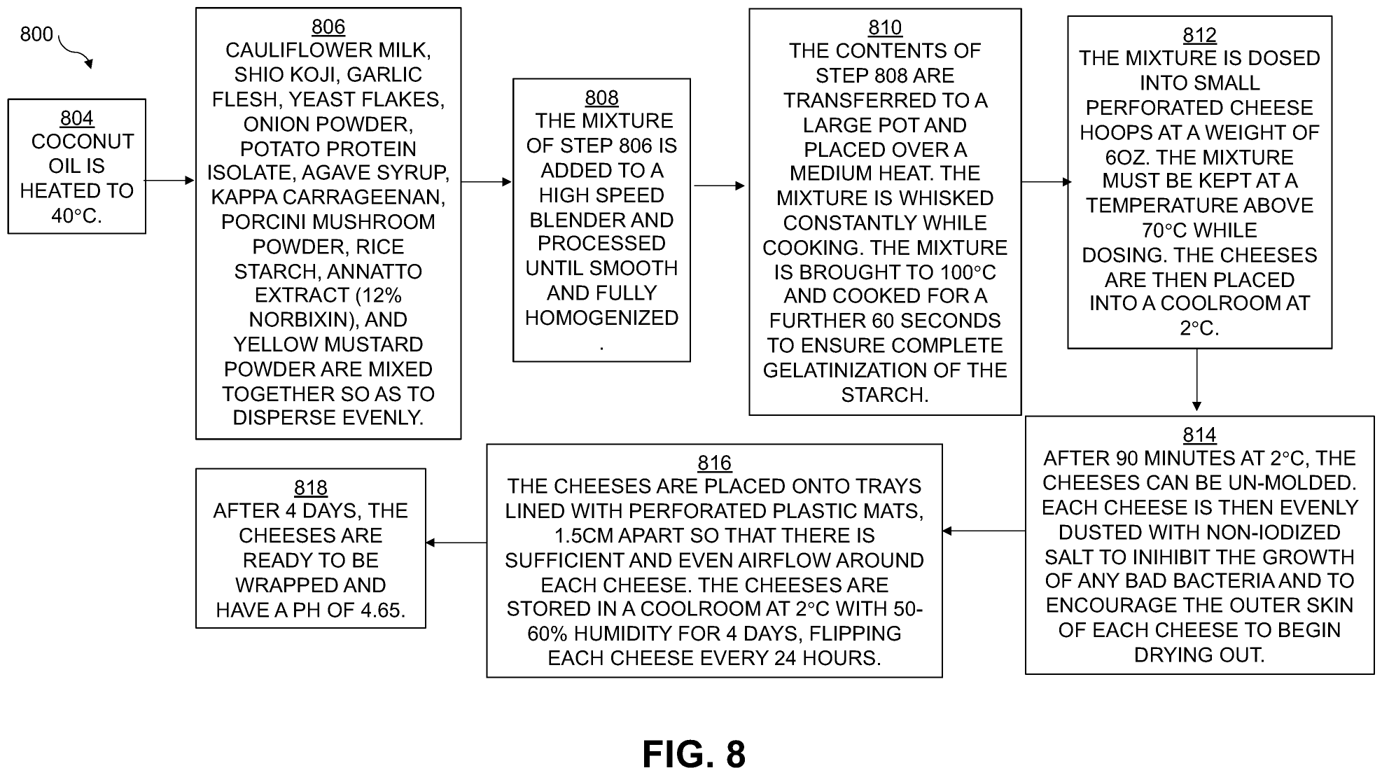

The process step 208 is followed by the process step 210 that includes adding the paste to the first mixture to form the second mixture. The process step 210 is followed by the process step 212 that includes heating the second mixture to approximately 95° C. The process step 212 is followed by the process step 214 that includes placing the second mixture in the mold (e.g., the silicone mold) until the second mixture reaches the room temperature to form the vegan cheese. The process step 214 is followed by the process step 216 that ends the method 200 to create the vegan cauliflower gruyere cheese from the cauliflower milk. It should be appreciated that the vegan cauliflower gruyere cheese may also be created by a method of FIG. 8.

### Example 4

The method 200 of FIG. 2 is used in Example 4. The process step 204 includes mixing approximately 200 grams of the cauliflower milk with approximately 2.6 grams of the kappa carrageenan as the stabilizer to form the first mixture. The process step 204 is followed by the process step 206 that includes stirring and heating the first mixture to the temperature of approximately 90° C. The process step 206 is followed by the process step 208, that includes blending the one or more ingredients to form the paste. The one or more ingredients include approximately 4.5 grams of the flesh of garlic, approximately 4.0 grams of the shio koji (made from the fungus Aspergillus Oryzae), approximately 6.0 grams of the yeast, approximately 105 grams of the coconut butter, approximately 1.8 grams of the onion powder, approximately 1.5 grams of the potato protein isolate, approximately 2.5 grams of the pink salt, approximately 8.0 grams of the agave nectar, approximately 1.5 grams of the porcini mushroom powder, approximately 8.0 grams of the rice starch, and approximately 1.5 grams of the yellow mustard powder.

The process step 208 is followed by the process step 210 that includes adding the paste to the first mixture to form the second mixture. The process step 210 is followed by the process step 212 that includes heating the second mixture to approximately 95° C. The process step 212 is followed by the process step 214 that includes placing the second mixture in the mold at the temperature of approximately 2° C. for approximately 1 hour. In examples, the mold is a silicone mold.

The process step 214 is followed by a new process step that includes removing the vegan cheese (e.g., the vegan cauliflower gruyere cheese) from the mold and placing the vegan cheese into containers lined with plastic draining mats. The containers are then placed into a refrigerator at a temperature in a range of approximately 2° C. to approximately 3° C. with humidity in a range of approximately 80% to approximately 85% for a time period of approximately 24 hours. After the 24 hours, the vegan cheese is sprinkled with sea salt and let age for another 7 days. The vegan cheese may be served after the 7 days.

### Example 5

The method 400 of FIG. 4 is used in Example 5. The process step 402 is followed by the process step 404, that includes mixing approximately 240 grams of cauliflower milk with approximately 27 grams of agar agar and approximately 2.2 grams of xanthan gum (as the stabilizers) and another milk (e.g., approximately 300 grams of oat milk) to form the first mixture.

The process step 404 is followed by the process step 406 that includes stirring and heating the first mixture to the temperature of approximately 90° C. The process step 406 is followed by the process step 408, that includes blending the one or more ingredients to form the paste. The one or more ingredients include approximately 45.0 grams of the tapioca starch, approximately 6.0 grams of the pea protein, approximately 4.0 grams of the yeast, approximately 4.0 grams of the onion powder, approximately 3.0 grams of the pink salt, approximately 90.0 grams of the coconut oil, and approximately 15.0 grams of the white miso paste.

The process step 408 is followed by the process step 410 that includes adding the paste to the first mixture to form the second mixture. The process step 410 is followed by the process step 412 that includes heating the second mixture to approximately 95° C. The process step 412 is followed by the process step 414 that includes placing the second mixture in the mold until the second mixture reaches the room temperature to form the vegan cheese. The process step 414 is followed by the process step 416 that ends the method 400 to create the vegan cauliflower and oat mozzarella cheese from the cauliflower milk and the oat milk.

### Example 6

A slight variation to the method 400 of FIG. 4 is used in Example 6. The process step 402 is followed by the process step 404, that includes mixing approximately 540.0 grams of the hemp seed milk (which may be created by the method 500 of FIG. 5) with approximately 5.0 grams of the agar agar or the kappa carrageenan and approximately 1.5 grams of the xanthan gum as the stabilizer to form the first mixture. The hemp seed milk may be formed by the method 500 of FIG. 5 described infra. The process step 404 is followed by the process step 406 that includes stirring and heating the first mixture to a temperature of approximately 90° C.

The process step 406 is followed by the process step 408, that includes blending the one or more ingredients to form the paste. The one or more ingredients of the process step 408 include approximately 45.0 grams of the tapioca starch, approximately 2.0 grams of the yeast, approximately 2.0 grams of the onion powder, approximately 6.0 grams of the pea protein, approximately 15.0 grams of the lemon juice, approximately 3.0 grams of the pink salt, approximately 90.0 grams of the coconut butter, and approximately 10.0 grams of the golden syrup.

The process step 408 is followed by the process step 410 that includes adding the paste to the first mixture to form the second mixture. The process step 410 is followed by the process step 412 that includes heating the second mixture to approximately 95° C. The process step 412 is followed by the process step 414 that includes placing the second mixture in the mold until the second mixture reaches the room temperature to form the vegan cheese (e.g., a vegan hemp mozzarella cheese). The process step 414 is followed by the process step 418 that includes removing the vegan cheese from the mold and storing the vegan cheese in the salt brine solution at a temperature of approximately 2° C. The salt brine solution is the 2.5% salt brine solution.

### Example 7

The method 200 of FIG. 2 is used in Example 7. The process step 204 includes mixing approximately 197.0 grams of the cauliflower milk (including the brown rice rejuvelac) with approximately 2.6 grams of the kappa carrageenan as the stabilizer to form the first mixture. The process step 204 is followed by the process step 206 that includes stirring and heating the first mixture to the temperature of approximately 90° C. The process step 206 is followed by the process step 208, that includes blending the one or more ingredients to form the paste. The one or more ingredients include: approximately 12.0 grams of the tapioca starch, approximately 6.0 grams of the yeast, approximately 1.5 grams of the onion powder, approximately 1.5 grams of the potato protein isolate, approximately 2.5 grams of the pink salt, approximately 33.0 grams of the cacao butter, approximately 7.8 grams of the agave nectar, approximately 1.2 grams of the porcini mushroom powder, approximately 8.0 grams of the rice starch, approximately 20.0 grams of the rapeseed oil, approximately 18.0 grams of the shio koji (made from the fungus Aspergillus Oryzae), and approximately 0.1 grams of the Penicillium Candidum.

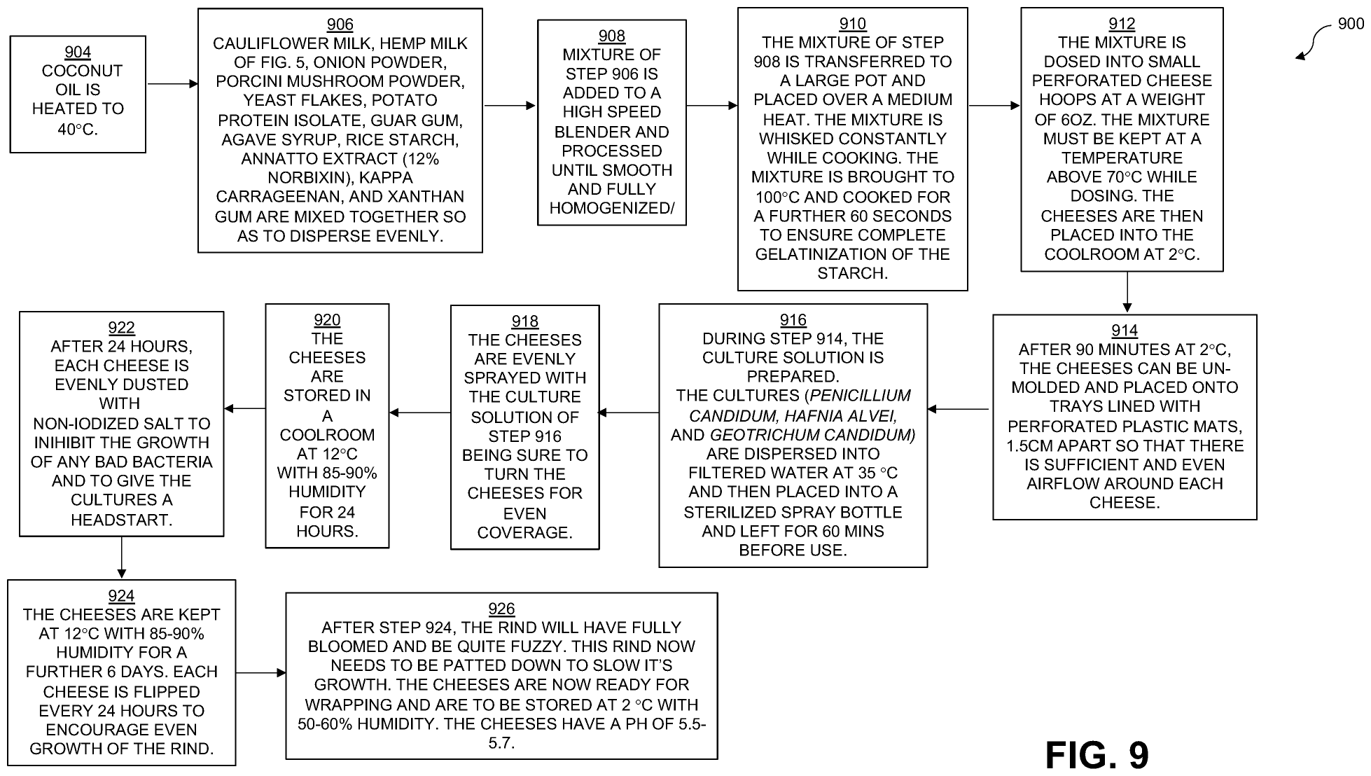

The process step 208 is followed by the process step 210 that includes adding the paste to the first mixture to form the second mixture. The process step 210 is followed by the process step 212 that includes heating the second mixture to approximately 95° C. The process step 212 is followed by the process step 214 that includes placing the second mixture in the mold until the second mixture reaches the room temperature to form the vegan cheese. The process step 214 is followed by the process step 216 that ends the method 200 to create the vegan camembert cheese from the cauliflower milk. It should be appreciated that the vegan camembert cheese may also be generated by a method 900 of FIG. 9.

### Example 8

The method 200 of FIG. 2 is used in Example 8. The process step 204 includes mixing approximately 200.0 grams of the cauliflower milk with approximately 1.0 grams of the xanthan gum and 0.4 grams of the locust bean gum as the stabilizers to form the first mixture. The process step 204 is followed by the process step 206 that includes stirring and heating the first mixture to the temperature of approximately 90° C. The process step 206 is followed by the process step 208, that includes blending the one or more ingredients to form the paste. The one or more ingredients include: approximately 48.0 grams of the shio koji (made from the fungus Aspergillus Oryzae), approximately 28.0 grams of the rice starch, approximately 95.0 grams of the coconut oil, approximately 10.0 grams of the agave nectar, approximately 1.2 grams of the pink salt, approximately 0.9 grams of the porcini mushroom powder, approximately 1.2 grams of the onion powder, approximately 0.8 grams of the yellow mustard powder, and approximately 6.0 grams of the yeast.

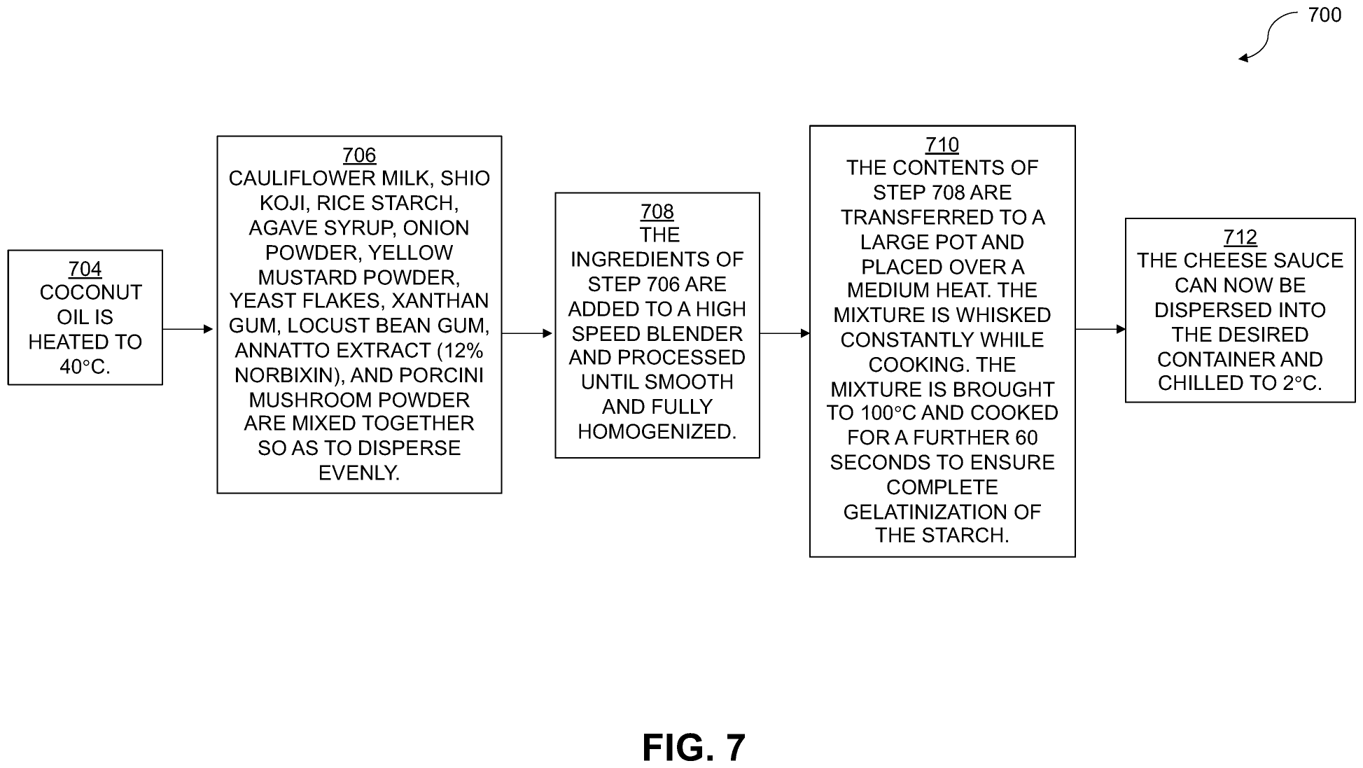

The process step 208 is followed by the process step 210 that includes adding the paste to the first mixture to form the second mixture. The process step 210 is followed by the process step 212 that includes heating the second mixture to approximately 98° C. The process step 212 is followed by the process step 214 that includes placing the second mixture in the mold and refrigerating the second mixture at approximately 2° C. The process step 214 is followed by the process step 216 that ends the method 200 to create the vegan cheese sauce from the cauliflower milk. It should be appreciated that the vegan cheese sauce may also be generated by a method 700 of FIG. 7.

### Example 9

Example 9 is formed via the method 600 to create a vegan cauliflower and hemp seed camembert cheese from cauliflower milk of FIG. 6. The method 600 begins with a process step 602, which is followed by the process step 604 that includes mixing a fungus, a bacterium, and water to create a first mixture. Specifically, the fungus is approximately 0.1 grams of Penicillium Candidum, the bacterium is approximately 0.1 grams of Hafnia Alvei, and the water is present in approximately 100.0 grams. The first mixture may be placed in a sterilized spray bottle.

The process step 604 is followed by the process step 606 that includes allowing the first mixture to stand at a room temperature for approximately 1 hour. The process step 606 is followed by the process step 608 that includes combining and blending the one or more ingredients to form the second mixture. The one or more ingredients include approximately 197.0 grams of the cauliflower milk, approximately 105.0 grams of the coconut butter, approximately 45.0 grams of the hemp milk, approximately 1.5 grams of the onion powder, approximately 1.1 grams of porcini mushroom powder, approximately 6.0 grams of yeast, approximately 1.5 grams of potato protein isolate, approximately 2.5 grams of pink salt, approximately 9.0 grams of agave nectar, approximately 1.5 grams of kappa carrageenan, approximately 8.0 grams of glutinous rice starch, and approximately 0.6 grams of locust bean gum.

The process step 608 is followed by the process step 610 that includes cooking the second mixture until the second mixture reaches a temperature above 98° C. This step may include placing the blended one or more ingredients into a stainless-steel pot and cooking over a medium heat, whisking constantly, until the paste starts to bubble and has reached the temperature above approximately 98° C.

The process step 610 is followed by the process step 612 that includes placing the second mixture in the mold (e.g., the silicone mold) at a temperature of approximately 2° C. for approximately 1 hour. The process step 612 is followed by the process step 614 that includes removing the second mixture from the mold and spraying the second mixture with the first mixture.

This process step may include spraying the first mixture evenly with the first mixture. The cheese may then be placed into containers lined with plastic draining mats and may be stored in a refrigerator at approximately 12.5° C. with a humidity in a range of approximately 85% to approximately 90%. The cheese may be aged for approximately 24 hours. The cheese may then be sprinkled with sea salt and allowed to age further for 7 days. After the 7 days, the cheese is covered in an approximately 1 mm layer of white mold (P. Candidum). Next, the cheese is patted down to flatten and slow the growth of the white mold. The process step 614 is followed by the process step 616 that concludes the method 600.

### Example 10

The method 100A is used in Example 10. The process step 104 involves mixing finely sliced cauliflower with a butter and a salt to form a mixture. The cauliflower is approximately 580.0 grams, the butter is approximately 65.0 grams of coconut butter, and the salt is approximately 4.0 grams of a pink salt. The process step 104 is followed by the process step 106 that includes stirring and heating the mixture until the mixture changes in color.

The process step 106 is followed by a process step 108 that includes blending the mixture with water to form a puree. The water is present in approximately 1230.0 grams. In some examples, the process step 108 may include blending the mixture with water, oat kvass, juice, and an extract. In this example, the oat kvass is present in approximately 580.0 grams, the juice is approximately 40.0 grams of a lemon juice, and the extract is approximately 0.2 grams of an Annatto Extract. The process step 108 is followed by the process step 110 that ends the method 100 to create the cauliflower milk. The cauliflower milk will keep for approximately 7 days if stored at approximately 2° C.

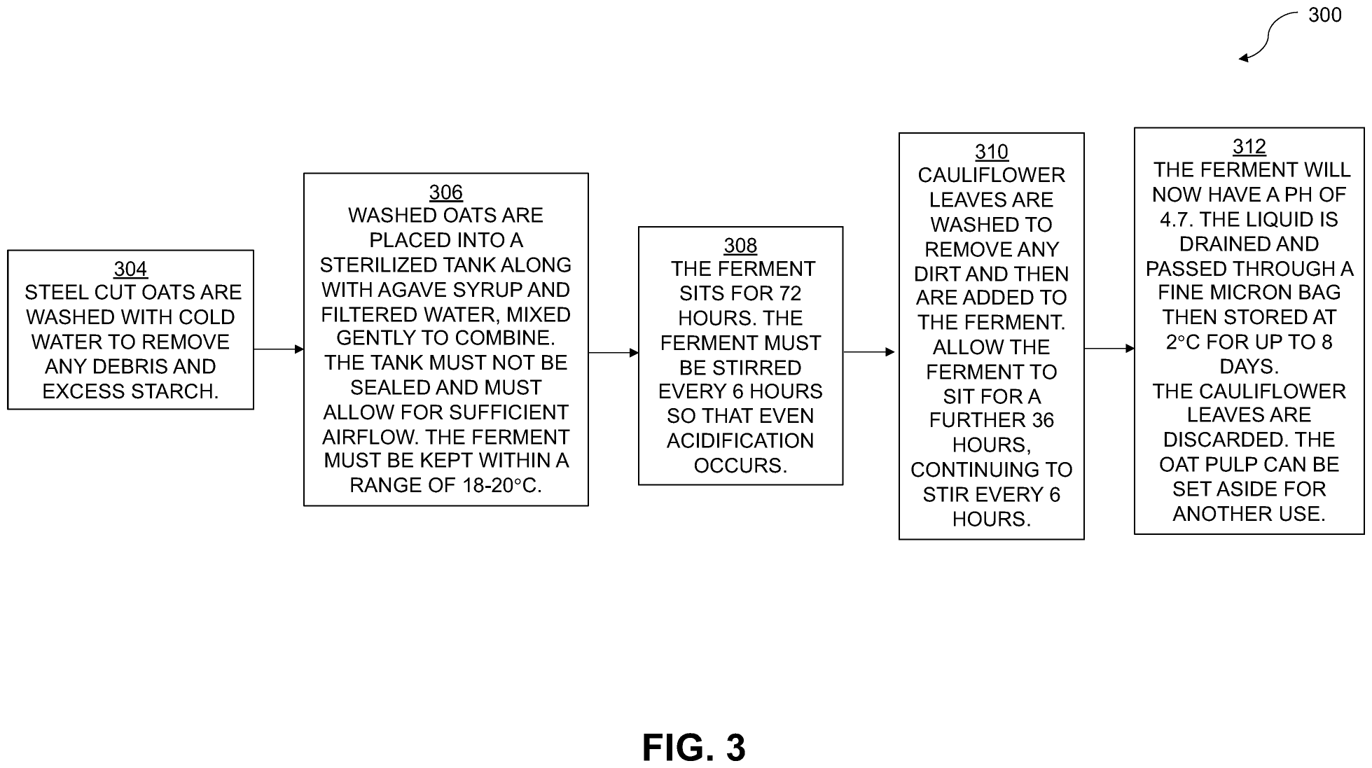

The oat kvass may be made by the following process: rinsing approximately 200.0 grams of steel cut oats with approximately 1400.0 grams of cold water until the water runs clear, adding the rinsed oats and filtered water to a sterilized container, covering the container with a cheese cloth and leaving the container in a dark, well ventilated area at a temperature of approximately 18° C. to approximately 20° C. for approximately 60 hours. The method further includes agitating the container to stir up the sediment and refresh the oxygen supply every 12 hours. After 60 hours, the oat kvass will have a cheesy, nutty aroma with a pH level of 4.5-4.6. Next, approximately 150.0 grams of cauliflower leaves are added to the container and stirred. The oat kvass is allowed to continue to age for another 36 hours. The liquid is then strained from the oats and the remaining solids are discarded. The oat kvass may be stored at approximately 2° C. for approximately two weeks. It should be appreciated that the oat kvass may also me made by a method 300 of FIG. 3.

### Example 11

Example 11 describes creation of a cream cheese. This example utilizes the hemp milk generated from FIG. 12. Approximately 70% hemp milk is emulsified in a large steam jacketed kettle with approximately 0.53% citrus fiber, approximately 0.15% guar gum, approximately 0.50% waxy rice starch, approximately 0.75% pre-gelled tapioca starch, approximately 0.09% dried garlic powder, approximately 0.19% dried onion powder, approximately 0.04% black tea extract, and approximately 0.56% lactic acid.

Once fully emulsified, approximately 1.75% sea salt is added and the mixture is continually blended for 2 minutes before adding approximately 15% refined coconut oil at 85° F. and approximately 10% high oleic sunflower oil. When the oils are fully combined, the cooking process beings. While blending on a medium shear, the temperature of the mixture is brought to approximately 162° F. The temperature is held here for approximately 10 minutes. The cooked mixture is then pumped to a twin screw horizontal mixer fitted with liquid nitrogen injection ports. While mixing, an internal temperature of the product is brought to approximately 110° F. Then, freeze-dried culture strains are added directly to the mixture. In examples, the freeze-dried culture strains are thermophilic lactic acid bacteria, including but not limited to, Streptococcus thermophilus and Lactobacillus delbrueckii subsp. bulgaricus.

Next, approximately 0.25% freeze dried and irradiated chives and approximately 0.09% freeze dried and irradiated dill are added directly to the mixture. The mixing process continues and the mixture is cooled to a temperature of approximately 60° F. The product is then placed into a piston filler and the product is dispensed into cups before being film sealed. The cups are then placed in a conveyor cooling tunnel, where the internal temperature of the product is brought down to approximately 35° F. This base recipe for cream cheese is also used to produce various flavor combinations.

### Example 12

Example 12 describes creation of a marinated goat cheese using the hemp milk created from FIG. 12. To create the marinated goat cheese, approximately 64% hemp milk is emulsified in a large steam jacketed kettle with approximately 1.06% citrus fiber, approximately 3% pre-gelled tapioca starch, approximately 0.03% black tea extract, approximately 0.46% glucano delta lactone (GDL), and approximately 0.6% lactic acid. Once fully emulsified, approximately 1.69% sea salt is added and the blending continues for 2 minutes before adding approximately 29% refined coconut oil at 85° F. When the oils are fully combined, the cooking process beings.

While blending the mixture on a medium shear, a temperature of the mixture is brought to approximately 162° F. The temperature is held here for approximately 10 minutes. The hot mixture is then directly dispersed into desired molds and placed onto racks. The mixture is blast chilled to a temperature of approximately 38° F. After 48 hours, the cheese can be de-molded and cut into the desired shape, placed into containers, and covered with a marinade oil. In examples, the marinade oil comprises: an approximately 60% high oleic sunflower oil and an approximately 40% extra virgin olive oil flavored with thyme, garlic, lemon, and black pepper. The container is then film sealed. This formula of Example 12 can also be used to produce a plain goat cheese that is kept in a 3% salt brine solution.

### Example 13

Example 13 describes a process to create a cheese-free cheese sauce. Approximately 30.32% of a naturally cultured oat milk formed from the method of FIG. 13, approximately 30.32% steamed cauliflower florets, approximately 5.83% shio koji, approximately 1.17% pre-gelled tapioca starch, approximately 3.50% waxy rice starch, approximately 0.70% hemp protein isolate, approximately 0.93% citrus fiber, approximately 0.12% guar gum, approximately 0.02% beta carotene, approximately 0.93% organic agave nectar, approximately 0.82% yeast extract, and approximately 0.03% black tea extract are placed in a steam jacketed kettle with high shear capabilities. The mixture is processed on high speed to form a smooth emulsion. Once achieved, approximately 0.37% sea salt is added.

Then, approximately 17.49% refined coconut oil and approximately 5.83% high oleic sunflower oil are added. The process is continued until the mixture is fully emulsified. The cooking process then begins, with the blades being set to a medium high speed. The temperature of the mixture is brought to approximately 165° F. and held there for approximately 10 minutes. The product may then be dispensed into desired packaging and cooled to a temperature of approximately 38° F. for storage.

### Example 14

Example 14 describes a method to create a hemp, oat, and cauliflower cheddar product. In Example 14, approximately 39.12% of the cultured oat and hemp milk (created from the method of FIG. 14), approximately 10% steamed cauliflower florets, approximately 12.28% modified potato starch, approximately 4.37% pre-gelled tapioca starch, approximately 0.11% konjac gum, approximately 0.08% guar gum, approximately 0.05% beta carotene, approximately 0.20% lactic acid, approximately 1.64% organic agave nectar yeast, and approximately 0.03% black tea extract are placed in a steam jacketed kettle with high shear capabilities. The mixture is processed on high speed to form a smooth emulsion. Once achieved, approximately 1.91% sea salt is added. Then, approximately 27.29% refined coconut oil is added at approximately 85° F. and the mixture is continually processed until fully emulsified.

Next, the cooking process begins, with blades set to a medium high speed. A temperature of the mixture is brought to approximately 165° F. and held there for approximately 10 minutes. The product can then be dispensed while hot (at approximately 165° F.) into a desired mold and placed in a blast chiller to cool the product to an internal temperature of approximately 38° F. The cheese may then be left for approximately 5 days at a temperature in a range of approximately 38° F. to 40° F. to mature before further processing. The formula of Example 14 can be processed for packaging in a variety of different formats, such as: slices, shreds, small single serve pucks, and/or single-serve sticks, among others.

### Example 15

Example 15 describes a process to create a flavored butter using the oat and hemp milk created from the method of FIG. 14. Approximately 16.79% cultured oat and hemp milk created from the method of FIG. 14, approximately 0.02% beta carotene, approximately 0.03% black tea extract, approximately 0.63% liquid sunflower lecithin, and approximately 0.06% dipotassium phosphate are placed in a steam jacketed kettle with high shear capabilities. Next, the mixture is processed on a high speed to form a smooth emulsion. Once the smooth emulsion is achieved, approximately 1.68% sea salt is added to the emulsion.

Then, approximately 50.37% refined coconut oil at 85° F. and approximately 30.43% high oleic sunflower oil is added to the emulsion. The mixture is continually processed until fully emulsified. Next, the cooking process beings with blades set to a medium high speed. A temperature of the mixture is then brought to a temperature of approximately 165° F. and held there for approximately 10 minutes. The product may then be dispensed while hot (e.g., at a temperature of approximately 165° F.) into the desired molds and placed in a blast chiller to cool to an internal temperature of approximately 38° F.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A vegan cheese comprising:
approximately 200.0 grams to approximately 500.0 grams of a cauliflower milk;
approximately 1.0 grams to approximately 20.0 grams of a yeast;
approximately 1.0 grams to approximately 6.0 grams of a salt;
approximately 1.0 grams to approximately 27.0 grams of a stabilizer;
approximately 30.0 grams to approximately 110.0 grams of a butter and/or approximately 20.0 grams to approximately 95.0 grams of an oil;
approximately 8.0 grams to approximately 45.0 grams of at least one starch; and
at least one other ingredient.

2. The vegan cheese of claim 1, wherein the at least one other ingredient is selected from the group consisting of: a mold, a bacterium, a fungus, a sweetener, a powder, a solid food substance, a liquid, and a paste.

3. The vegan cheese of claim 2,
wherein the mold is present in a range of approximately 4.0 grams to approximately 48.0 grams,
wherein the mold is shio koji, and
wherein the shio koji is made from a fungus Aspergillus Oryzae.

4. The vegan cheese of claim 2,
wherein the bacterium is present in approximately 0.1 grams, and
wherein the bacterium is selected from the group consisting of: Lactococcus lactis subsp. Cremoris, Hafnia Alvei, Lactococcus lactis subsp. lactis biovar diacetylactis, Lactococcus lactis subsp. Lactis, Streptococcus salivarius subsp. thermophilus, Lactobacillus delbrueckii subsp. Bulgaricus, Lactobacillus helveticus, and Lactobacillus delbrueckii subsp.

5. The vegan cheese of claim 2,
wherein the fungus is present in approximately 0.1 grams, and
wherein the fungus is selected from the group consisting of: Geotrichum candidum and Penicillium Candidum.

6. The vegan cheese of claim 2, wherein the sweetener is a golden syrup or a maple syrup present in a range of approximately 4.0 grams to approximately 10.0 grams or an agave nectar present in a range of approximately 7.5 grams to approximately 10.0 grams.

7. The vegan cheese of claim 2,
wherein the powder is present in a range of approximately 1.0 grams to approximately 6.0 grams, and
wherein the powder is selected from the group consisting of: an onion powder, a pea protein powder, a potato protein powder, a porcini mushroom powder, and a yellow mustard powder.

8. The vegan cheese of claim 2, wherein the solid food substance is a skin of the potato present in a range of approximately 100.0 grams to approximately 175.0 grams or a skin of the garlic is present in a range of approximately 4.5 grams to approximately 11.0 grams.

9. The vegan cheese of claim 2, wherein the liquid is selected from the group consisting of: a lemon juice, a water, an oat milk, and a hemp seed milk.

10. The vegan cheese of claim 9,
wherein the lemon juice is present in a range of approximately 10.0 grams to approximately 20.0 grams,
wherein the water is present in a range of approximately 100.0 grams to approximately 220.0 grams, and
wherein the oat milk or the hemp seed milk is present in a range of approximately 45.0 grams to approximately 540.0 grams.

11. The vegan cheese of claim 2,
wherein the paste is white miso paste, and
wherein the paste is present in a range of approximately 15.0 grams to approximately 28.0 grams.

12. The vegan cheese of claim 1, wherein the stabilizer is selected from the group consisting of: xanthan gum, agar agar, IOTA Carrageenan, locust bean gum, and kappa carrageenan.

13. A method to create a vegan cheese from cauliflower, the method comprising:
mixing cauliflower milk with a stabilizer to form a first mixture;
stirring and heating the first mixture to a temperature of approximately 90° C.;
blending one or more ingredients to form a paste;
adding the paste to the first mixture to form a second mixture;
heating the second mixture to approximately 95° C.; and
placing the second mixture in a mold until the second mixture reaches a room temperature to form the vegan cheese.

14. The method of claim 13, further comprising:
creating the cauliflower milk by:
mixing approximately 800.0 grams of a finely sliced cauliflower with approximately 75.0 grams of a coconut butter and approximately 4.0 grams of a pink salt to form a mixture;
stirring and heating the mixture until the mixture changes in color; and
blending the mixture with approximately 1230.0 grams of a water to form a puree.

15. The method of claim 14, wherein the blending of the mixture with the approximately 1230.0 grams of the water to form the puree further comprises blending the mixture with approximately 600.0 grams of a brown rice rejuvelac and approximately 20.0 grams of a lemon juice.

16. The method of claim 13,
wherein the mixing the cauliflower milk with the stabilizer to form the first mixture further comprises mixing the cauliflower milk with an oat milk and the stabilizer to form the first mixture, and
wherein the oat milk is created by:
soaking approximately 180.0 grams of gluten free rolled oats in approximately 1920.0 grams of filtered water for approximately 12 hours; and
blending the gluten free rolled oats and the filtered water.

17. The method of claim 13, further comprising:
removing the vegan cheese from the mold;
storing the vegan cheese in a salt brine solution,
wherein the salt brine solution is a 2.5% salt brine solution, and
wherein the 2.5% salt brine solution comprises approximately 500.0 grams of water mixed with approximately 12.5 grams of salt.

18. The method of claim 13,
wherein the one or more ingredients are selected from the group consisting of: a yeast, a salt, a butter, an oil, a starch, and at least one other ingredient, and
wherein the at least one other ingredient are selected from the group consisting of: a mold, a bacterium, a fungus, a sweetener, a powder, a solid food substance, a liquid, and a paste.

19. A method to create a hemp milk from filtered water and hulled hemp hearts, the method comprising:
milling hemp seeds through a grinder to produce a hemp cream;
pulling the hemp cream through one or more screens; and
filtering the hemp cream through a fiber filter to create the hemp milk.

20. A method to create an oat milk, the method comprising:
adding oats and water into a fermentation tank;
maintaining a temperature of a mixture in the fermentation tank at approximately 85° F. for 48 hours;
stirring the mixture in the fermentation tank every six hours to ensure even acidification during fermentation;
passing the mixture over a sieve to remove pieces of the oats; and
passing the mixture through a filter to remove unwanted particles to create the oat milk.
